(19) United States
(12) Patent Application Publication
(10) Pub. No.: US 2025/0179667 A9
(43) Pub. Date: Jun. 5, 2025

(54) SEALING DEVICE AS A CELL PERIPHERY FOR AN ELECTROLYTIC-CELL STACK

(71) Applicant: H2i GreenHydrogen GmbH, Wallern an der Trattnach (AT)

(72) Inventor: Dietmar NEUBACHER, Graz (AT)

(73) Assignee: H2i GreenHydrogen GmbH, Wallern an der Trattnach (AT)

(21) Appl. No.: 18/682,473

(22) PCT Filed: Aug. 11, 2022
(86) PCT No.: PCT/AT2022/060280

§ 371 Date: Feb. 9, 2024

(30) Foreign Application Priority Data
Aug. 13, 2021 (AT) A50661/2021

(51) Int. Cl. C25B 9/73; C25B 9/60

(52) U.S. Cl. CPC C25B 9/73; C25B 9/60

(57) ABSTRACT

The disclosure relates to an electrolysis device for producing gaseous hydrogen, comprising at least one electrolytical cell extending along a cell axis, at least two flow channels and a sealing means. The sealing means is designed such that advantageous sealing of the electrolysis device and more particularly of its at least two flow channels is ensured. The disclosed electrolysis device having the advantageously designed sealing means is especially characterized by an increased service life of the individual components of the electrolysis device, by increased safety of the electrolysis device per se and by increased eco-nomic economy with respect to multiple possible life cycles of the electrolysis device while at the same time high operational requirements regarding the levels of and fluctuations in pressure and temperature are placed on the electrolysis device.

The invention relates to an electrolysis device for producing gaseous hydrogen as specified in the claims. In particular, the disclosed electrolysis device is characterized by a sealing device which ensures a particularly high and long-term reliable degree of tightness of the electrolysis device.

In EP1601041B1, a fuel cell stack with a spring module is shown, which spring module comprises two mutually displaceable components and a plurality of springs arranged between the first and second components. Furthermore, the fuel cell stack is provided with an adjusting screw and an end plate, the spring module being arranged between the end plate and a stack of fuel cells and the adjusting screw being arranged between the spring module and the end plate. In terms of safety and usability, especially with regard to sealing the cell stacks, this known configuration is only a partially satisfactory technical solution.

Furthermore, DE10058381B4 discloses an adaptive pressure distribution system for a modular multifunctional fuel cell stack, which comprises stainless steel bolts, a fiber-reinforced plastic carrier, adapted seals and other elements. Furthermore, spiral disc springs with integrated washers are provided at least one end of this device to tension the fuel cell stack for uniform pressure build-up and pressure maintenance. Again, this disclosed technical solution for building up a preload pressure for sealing is only partially satisfactory.

The object of the present invention was to overcome the disadvantages of the prior art and to provide a device and a method by means of which, among other things, the operational safety and effectiveness of an electrolysis device is increased.

This object is achieved by a device and a method according to the claims.

The electrolysis device according to the invention for producing gaseous hydrogen comprises at least one electrolysis cell extending along a cell axis, which is constructed from plate-shaped elements stacked or lined up along the cell axis. Furthermore, the electrolysis device comprises at least two apertures in the plate-shaped elements, wherein the apertures each form flow channels whose main directions extend along the cell axis. The main direction in this sense means that the main orientation of a straight line averaged in a longitudinal projection of a flow channel shows a main direction of a flow channel, which main direction extends along the cell axis, wherein this does not necessarily have to be parallel to the cell axis. In particular, the main direction of a flow channel extends along the main direction of the cell axis.

Furthermore, the electrolysis device comprises at least one sealing means or sealing device for ensuring the tightness of the electrolysis device. This sealing means comprises a first abutment element and a second abutment element, which abutment elements are spaced apart from one another in the direction of the cell axis. Furthermore, the sealing means comprises a first pressure plate and a second pressure plate, which are spaced apart from one another in the direction of the cell axis and are arranged between the first abutment element and the second abutment element, wherein the at least one electrolytic cell is arranged between the first pressure plate and the second pressure plate. The sealing means further comprises at least one retaining element to retain the first abutment element and the second abutment element along the cell axis at a predetermined distance. Furthermore, at least one elastically deformable or resilient pressure element is configured at least between a pair of an abutment element and a pressure plate that are closest to each other.

In this electrolysis device, it is provided that at least one elastically deformable pressure element is associated with each of the flow channels, and that a pressure element cross-section of at least one of these pressure elements projected along the cell axis is positioned so as to at least partially overlap a flow channel cross-section projected along the cell axis.

The advantage here is that the at least one elastically deformable pressure element creates a directed cone of force, so that the flow of force is guided in the direction of the main direction of a flow channel. This results in an improved seal, particularly in the area of the flow channel, against the surrounding or outer area of the electrolysis device and against an inner area of the electrolysis cell. The improved sealing of the flow channels from the interior should be emphasized here in particular, as this results in increased safety and a particularly low potential danger for the electrolysis device. At the same time, improved sealing of the electrolysis device against the outside area increases the effectiveness of the electrolysis device, since hydrogen, as the smallest element in the periodic table, has a high tendency to diffuse in relation to its dimensions in its molecular state.

Another positive effect that should be emphasized is that the interaction of the abutment element, pressure plate and the at least one elastically deformable pressure element ensures im-proved sealing of the electrolysis device, especially in pressurized operation. This has a particularly positive effect in the case of pulsating pressure operation in combination with process-related temperature changes, wherein these combined operating states may definitely exist in the operation of an electrolysis device. The described interaction, in particular the use of the disclosed sealing device or the sealing means used for this purpose, makes it possible to control the sliding of sealing planes, which may be associated with the plate-shaped elements, in a defined manner. As a result, increased operational reliability with a simultaneously extended operating spectrum and an extended service life or a longer, uninterrupted service life of the electrolysis device may be achieved.

Another advantageous configuration is one according to which it may be provided that with each of the flow channels is associated a pressure element and that a center axis of each of the pressure elements is aligned with the main direction of the respective flow channels. This configuration is particularly advantageous if process and/or operation related, pulsating temperature and/or pressure fluctuations within the electrolytic cell result in thermal expansion of the plate-shaped elements, causing the plate-shaped elements to slide relative to each other.

The pressure or force introduction aligned with the flow channels and the associated formation of a cone of force along the main directions of the flow channels prevents a relative sliding offset of individual plate-shaped elements in relation to the respective flow channel. This prevents changes in the flow cross-section of the flow channels and also improves the sealing of the flow channels and increases the safety of the electrolysis device.

In addition, it may be provided that the flow channels are formed by elliptical apertures in the plate-shaped elements and that each flow channel is associated with two pressure elements. This results in the mutually beneficial effect that, on the one hand, the elliptical flow channels are provided with a reduced inner surface of the flow channel in the vicinity of the outer and inner surface of the electrolytic cell, while at the same time the same flow throughput is ensured by the corresponding dimensioning of the elliptical flow channel cross-section. On the other hand, there is the synergetic effect that the two pressure elements associated with each flow channel in turn improve the sealing of the elliptical flow channels along the main axis of the elliptical flow channel cross-section.

Furthermore, it may be expedient for the flow channels to be distributed in the circumferential direction of the electrolysis device, wherein the normal distance of the center axis to the cell axis of a pressure element associated with the respective flow channel is less than the normal distance of the main direction to the cell axis of the respective flow channel. The cone of force created by the pressure elements, which is offset in the direction of the inner area of the electrolytic cell, is particularly advantageous for improving the sealing of the flow channels against this inner area of the electrolytic cell. As mentioned above, the tightness of the flow channels against the inner area of the electrolytic cell is particularly important due to the reactivity of the product gases of the electrolysis. This measure therefore ensures improved operational safety.

Furthermore, it may be provided that the at least one retaining element comprises a guide arrangement by means of which the first pressure plate and/or the second pressure plate is guided adjustably relative to the first abutment element and/or the second abutment element along the cell axis. This advantageous design ensures that the electrolysis device is optimally sealed at all times by guiding the pressure plates in dynamically occurring operating modes or operating states. Particularly with regard to strong fluctuations in temperature and the resulting thermal expansion of the components of the electrolysis device, excessive sliding of the plate-shaped elements is prevented by the design disclosed. At the same time, all components of the electrolysis device are handled with care, as dynamic effects are dampened; for example excessive surface pressure due to thermal expansion of individual sensitive elements is avoided. As a result, thinner panel-shaped elements can be used, which has far-reaching positive effects in terms of production technology and therefore also economically. This advantageous design is particularly beneficial with regard to the economic interchangeability of individual components and the associated resource-saving operation over several life cycles of an electrolysis device.

According to a particular embodiment, it is conceivable that the at least one retaining element comprises a bolt, a pin, a cable or, in particular, a screw, or is formed by at least one of these elements, which at least one retaining element passes through the first and second pressure plate in the direction of the cell axis. On the one hand, this results in a very compact design of the entire electrolysis device, which has far-reaching advantages with regard to its use in a modular system, for example. Secondly, this embodiment favors an ideal, in particular a preferably jam-free or smooth-running guidance of the pressure plates along the guide arrangement, which conversely results in a reduced surface pressure between the plate-shaped elements compared to conventional embodiments.

According to another advantageous embodiment, it may be provided that the elastically deformable pressure elements are formed by helical springs and/or disc springs, in particular by equally layered disc springs, wherein a first group of these pressure elements is passed through by a respective retaining element in the direction of the cell axis. This results in a homogenization of the pressure across the entire cross-section of the electrolysis device and therefore also an improved seal for the electrolysis cell. The temperature and pressure induced sliding of the plate-shaped elements is also improved by avoiding localized stress peaks. At the same time, this homogenization enables the use of thinner printing plates and it is also possible to use pressure plates made of plastics or other less rigid materials than metals. This ensures that the stiffness and stability of the electrolysis device is transferred to the abutment elements, while at the same time achieving improved sealing during dynamic operation thanks to the increased flexibility of the pressure plates.

In addition, it may be provided that a second group of the pressure elements is formed by the pressing elements associated with the flow channels, wherein the pressing elements of the second group have a different, in particular a higher pressure force than the pressure elements of the first group. This creates an advantageous configuration in which the pressure of the plate-shaped elements over the entire contact surface can be ideally controlled in accordance with the requirements regarding the sliding of the plate-shaped components under thermal expansion and/or compressive strain. For example, a high pressure force in the area of the flow channels and a comparatively lower pressure force may be set, taking into account the resulting and overlapping cones of force, in order to impose a defined direction of expansion, a de-fined form of expansion and order of magnitude on the sliding of the plate-shaped elements with regard to the operational requirement states.

In particular, it may be advantageous for at least one elastically deformable pressure element to be arranged between each of the nearest pairs of an abutment element and a pressure plate. The advantage here is that the pressure of the plate-shaped elements may be adjusted from both sides or from both axial ends of the electrolysis device or is optimized to ensure tightness along the cell axis across all plate-shaped elements. The effect of the pressure element is thus homogenized by the double-sided arrangement over the length of the cell stack, which results above all in the further synergetic effect that electrolysis devices with a plurality of electrolytic cells may be sealed in an ideal manner, as already explained. Thus, an economic advantage over the known embodiments may be achieved, wherein the advantages already described above with regard to the saving of resources for the production of individual components of the electrolysis device are further optimized.

Furthermore, it may be expedient if the sealing means or the sealing device is designed asymmetrically with respect to the number and/or configuration of the elastically deformable pressure elements relative to a center plane of the electrolysis device aligned normal to the cell axis. Since the pressure levels and temperature strains in an electrolysis device with several half cells within the electrolytic cell are not necessarily evenly distributed along the cell axis or symmetrical in relation to a normal plane of the cell axis, it is advantageous to react to this inhomogeneity by means of the elastically deformable pressure elements. Thus, the individual adaptation of the pressure elements has the advantageous effect of again improving the sealing of the entire electrolysis device over the entire expansion length along the cell axis.

According to a further advantageous embodiment, it may be provided that the at least one elastic pressure element is positioned so that it can slide in the direction of the cell axis by means of pockets and/or a mandrel provided in the respective abutment element and/or in the respective pressure plate. The precise positioning of the at least one pressure element is advantageous. Furthermore, this further embodiment makes it easy to use pressure elements that are composed of individual elements that are not firmly connected, which makes it possible to precisely influence the characteristic curve of the compression spring of the pressure elements as well as the linear pressure of the same on their contact surfaces with the abutment element and pressure plate. In particular, the maximum spring deflection may subsequently be influenced by this further embodiment, which is particularly advantageous with regard to an indication of the operating limits of the electrolysis device in order to detect any damage or overstressing at an early stage.

In addition, it may be provided that the stiffness of a pressure plate is less than or equal to the stiffness of the abutment element closest to it. The advantage here is that component uneven-ness is absorbed or at least partially compensated for by the pressure plate, while at the same time the abutment element ensures the stability of the electrolysis device in the composition of the entire sealing device. At the same time, this can compensate for signs of fatigue in the pressure elements.

Furthermore, it may be provided that the pressure plate for the elastic pressure elements includes flat receiving surfaces, wherein the receiving surfaces are connected by means of web-like structural elements. The advantage here is that the flat receiving surfaces improve the formation of a specified cone of force for precise sealing of the flow channels in accordance with their requirements due to the load from the pressure elements in conjunction with the web-like structural elements. At the same time, the directional flow of force through a suitable arrangement of the web-like structural elements means that less material is used for the pressure plates, which not only saves resources but also brings economic benefits.

Furthermore, a method for sealing an electrolysis device is provided, wherein a first pair of a pressure plate and a nearest abutment element with pressure elements associated with the first pair is pretensioned by means of a pretensioning device and arranged along the cell axis.

Subsequently, at least one electrolytic cell made up of plate-shaped elements is stacked along the cell axis next to the first pair. In addition, a second pair of a pressure plate and a nearest abutment element with pressure elements associated with the second pair is pretensioned by means of a further pretensioning device and is then lined up to the at least one electrolytic cell along the cell axis. Furthermore, the abutment element of the first pair is retained at a predetermined distance from the abutment element of the second pair by means of at least one retaining element. Finally, each pretensioning device is released from the respective pair of pressure plate and abutment element and the pretensioning force of the sealing device is finely adjusted by means of the at least one retaining element so that the sealing of the plate-shaped elements of the at least one electrolytic cell and thus of the electrolytic device is achieved.

The main advantage of this method is that the respective pair of pressure plate and nearest abutment element with the corresponding pressure elements is stacked or lined up along the cell axis in a pretensioned state. This enables a predefined pre-tensioning and thus sealing of the electrolysis device by means of the sealing device during the assembly process. Furthermore, the pressure force on the flat sides of the plate-shaped elements may be homogenized, which means that no inhomogeneous load situation occurs during the assembly process. This achieves a radially uniform tensioning, which is particularly advantageous with regard to the service life of the plate-shaped elements used.

For the purpose of better understanding of the invention, this will be elucidated in more detail by means of the figures below.

These show respectively in a very simplified, schematic and exemplary representation:

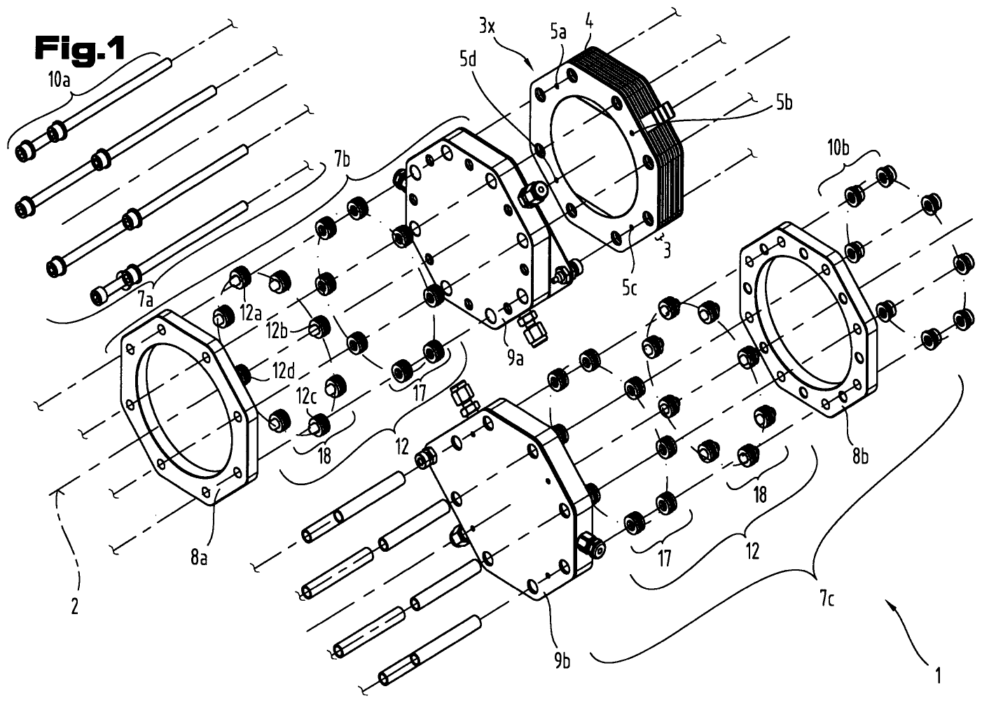

FIG. 1 an exploded view of a possible configuration of the electrolysis device;

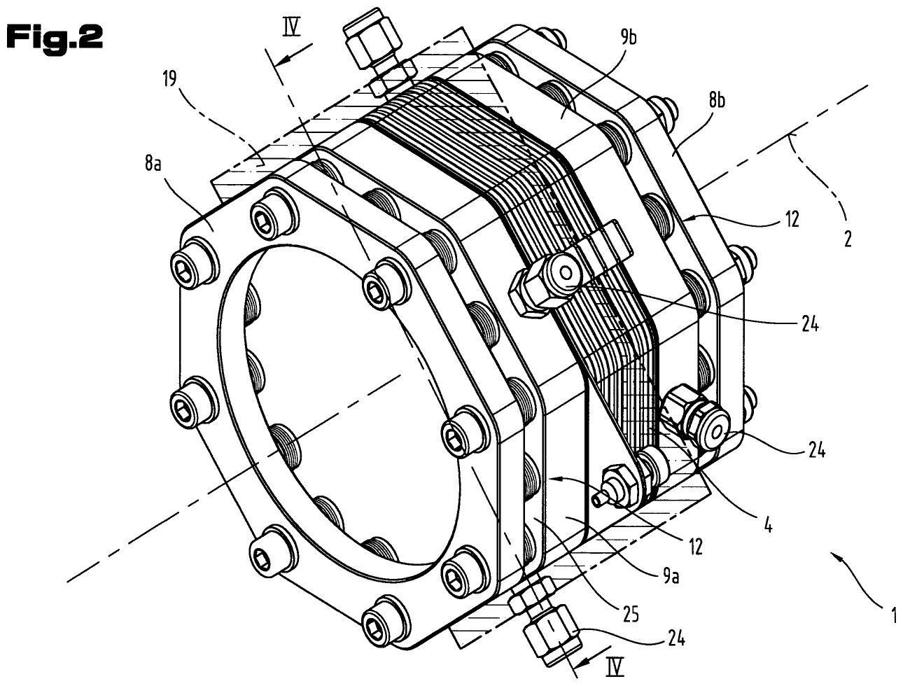

FIG. 2 a perspective view of the electrolysis device according to FIG. 1;

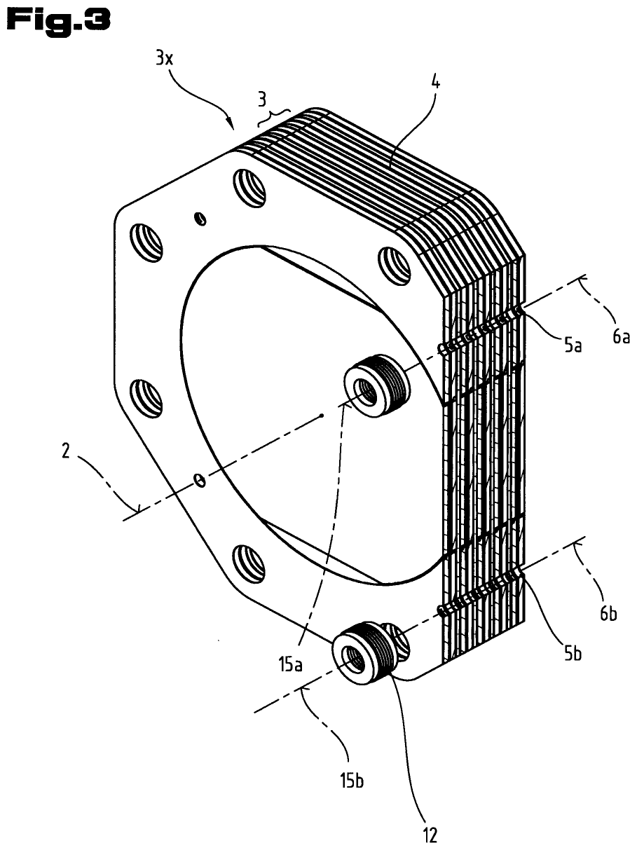

FIG. 3 a sectional view through the electrolytic cell of the electrolysis device to illustrate a possible configuration of the flow channels through the plate-shaped elements of the electrolytic cell in connection with the arrangement of resilient pressure elements;

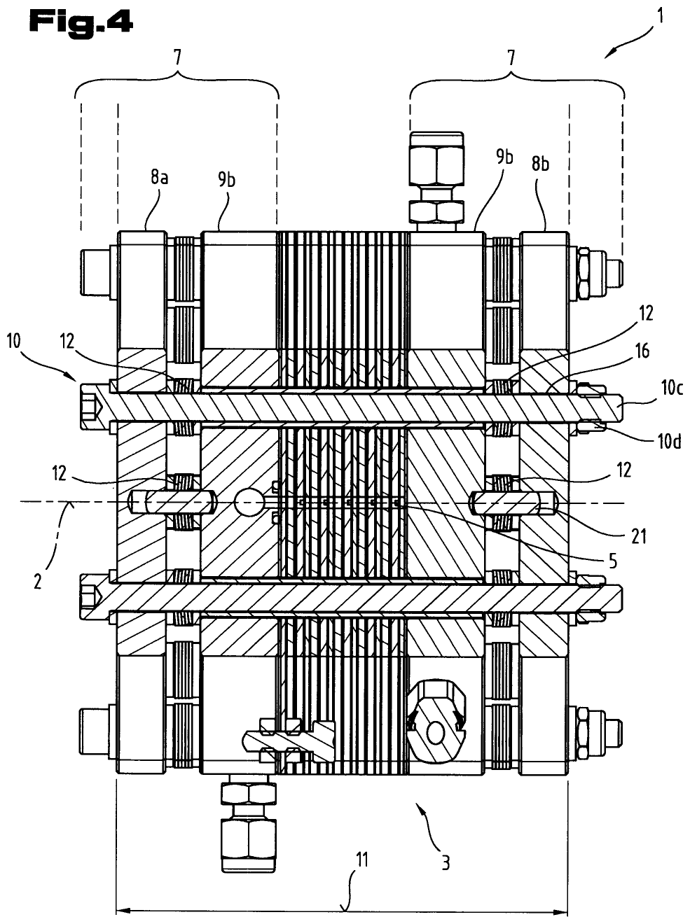

FIG. 4 a highly simplified and schematic representation of a longitudinal section through the electrolysis device;

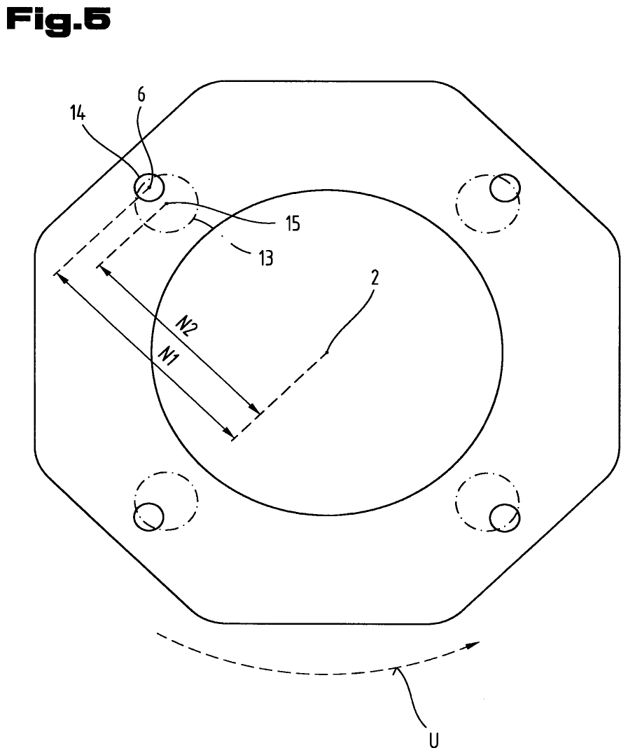

FIG. 5 a representation of the projected cross-sections of the pressure elements, flow channels and retaining elements in a possible configuration of the arrangement of the pressure elements;

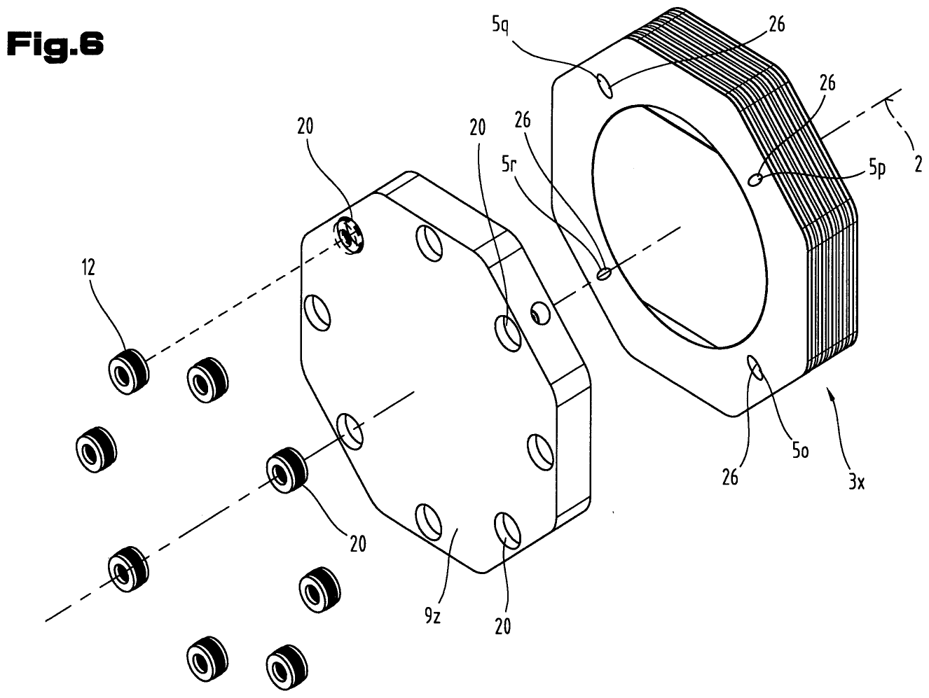

FIG. 6 a possible configuration of the pressure plate and the flow channels through the plate-shaped elements; and

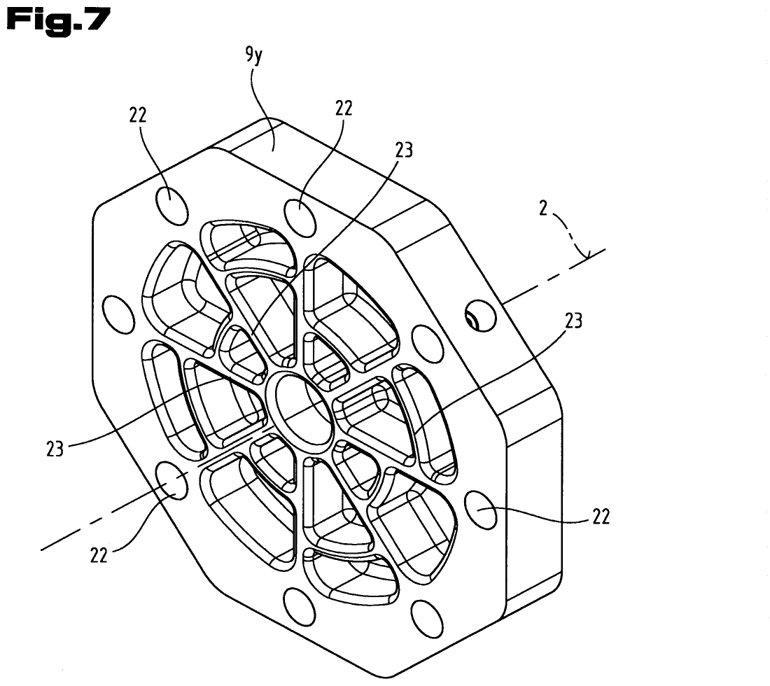

FIG. 7 a possible configuration of the pressure plate in a highly simplified and schematic representation;

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

According to the reference signs list, terms from the reference signs list are used in the description with and/or without a specific index. If it is not necessary to differentiate between the terms in terms of their specific form, no indices are used. Conversely, for example, a pressure element 12a can be differentiated from a pressure element12b according to the respective description, wherein both are still each a pressure element 12.

FIG. 1 shows an exploded view of an embodiment of the electrolysis device 1. The electrolysis device 1 comprises at least one electrolytic cell 2 arranged along the cell axis 3, wherein the electrolytic cell 3 may consist of plate-shaped elements 4 stacked along the cell axis 2.

The plate-shaped elements 4 may include flow channels 5 which are formed by apertures in the plate-shaped elements 4. In particular, the flow channels 5 extending parallel or essentially parallel to the cell axis 2 are formed by the apertures in the serially arranged or adjoining plate-shaped elements 4. Furthermore, the electrolysis device comprises sealing means 1, in particular at least one sealing device 7, which in FIG. 1 is divided into the parts 7a, 7b and 7c, which sealing device 7 may comprise two abutment elements 8, two pressure plates 9 and elastically deformable pressure elements 12. Furthermore, the flow channels 5 may have a fluidic connection to the pressure plates 9 if, for example, diversion channels, connecting channels and/or fluid connections for the electrolysis device 1 are provided in the pressure plates 9. As shown, the electrolysis device 1 may comprise retaining elements 10, which retaining elements 10 in this possible embodiment are realized by means of screws 10a and nuts 10b. As can be seen, the individual plate-shaped elements of the electrolysis device 1 along the cell axis 2 are arranged stacked or lined up along the cell axis and the sealing de-vice 7 consists of two pairs of one pressure plate 9 and the nearest abutment element 8 with intermediate pressure elements 12 between them. The electrolytic cell 3 is arranged between these two pairs disposed at the front, each consisting of a pressure plate 9 and the nearest abutment element 8. It is conceivable to arrange a plurality of electrolytic cells 3x between these pairs. In other words, the pairs each consisting of a pressure plat 9 and a nearest abutment element 8 each are formed in relation to the cell axis 2 at the axial face ends of the electrolysis device 1.

Furthermore, it may be provided that each of the flow channels 5a, 5b, 5c and 5d is associated with at least one elastically deformable pressure element 12a, 12b, 12c, 12d. As shown in the illustrated embodiment, the pressure elements 12 may, for example, be configured as equally layered disc springs. A first group 17 of these pressure elements 12 may be passed through by one retaining element 10 each in the direction of the cell axis 2. Furthermore, a second group 18 of pressure elements 12 may be formed by the pressure elements 12 associated with the flow channels 5a, 5b, 5c and 5d. This second group 18, as shown as an example in this embodiment, may also be associated with further pressure elements 12. The pressure elements 12 of the second group 18, especially the pressure elements 12 which are each associated with a flow channel 5, may have a different, in particular a higher pressure force than the pressure elements of the first group 17.

FIG. 2 shows the configuration of the electrolysis device according to FIG. 1 in an assembled state. To supply the electrolysis device 1 and/or for the disposal of products from the electrolysis device 1, the pressure plates 9a and 9b may be provided with corresponding fluid connections 24, wherein in this sense also gaseous components or multiphase mixtures may also be supplied and/or disposed via the fluid connections 24. Thus, as already mentioned, flow channels 5 of the electrolysis device 1 may be provided with a fluidic connection in the pressure plates 9 to the fluid connections 24. An embodiment is also conceivable in which all fluid connections 24 of the electrolysis device 1 on a common pressure plate 9 or on a flat side 25 of a pressure plate 9 are arranged.

FIG. 3 shows the flow channels 5 in the plate-shaped elements 4 of the electrolytic cell 3 in connection with the arrangement of the pressure elements 12, wherein the same reference signs or component designations are used for the same parts as in the previous FIGS. 1 and 2. In order to avoid unnecessary repetition, reference is made to the detailed description for the previous FIGS. 1 and 2. FIG. 3 shows a plurality of electrolytic cells 3x, which consist of plate-shaped elements 4 along the cell axis 2. In this possibly independent embodiment, it may be seen that a respective flow channel 5a and/or 5b is each associated with a pressure element 12a, 12b, wherein the respective center axis 15a, 15b of each of the pressure elements 12a, 12b to the main direction 6a, 6b of the respective flow channel 5a and/or 5b may be aligned. Preferably, each of the two axial ends of the electrolysis device 1 is provided with a group of pressure elements 12a, 12b, as can best be seen in FIG. 4.

FIG. 4 shows a longitudinal sectional view of the electrolysis device 1, wherein the same reference signs or component designations are used for the same parts as in the previous FIGS. 1, 2 and 3. In order to avoid unnecessary repetition, reference is made to the detailed description for the previous FIGS. 1, 2 and 3. FIG. 4 shows that a retaining element 10 may comprise a guide arrangement 16 through which the first pressure plate 9a and/or the second pressure plate 9b are guided relative to the first abutment element 8a and/or second abutment element 8b along the cell axis 2. This results in the advantageous effects already described with regard to the sealing effect of the sealing device or the sealing means 7. Furthermore, a retaining element 10 may be formed by a combination of a screw 10c with a nut 10d, which at least one retaining element 10 is passed through the first and the second pressure plate 9a, 9b in the direction of the cell axis 2. Furthermore, it may be provided that pressure elements 12 are disposed in a gliding movement configuration by means of an abutment element 8 and/or a mandrel 21 disposed in the respective pressure plate 9 in the direction of the cell axis 2.

FIG. 5 shows an advantageous arrangement or relative positioning of the projected cross-sections of the pressure elements 12, the flow channels 5 and the retaining elements 10, wherein the same reference signs or component designations are used for the same parts as in the previous FIGS. 1 to 4. In order to avoid unnecessary repetition, reference is made to the detailed description for the previous FIGS. 1 to 4. FIG. 5 shows an embodiment of the electrolysis de-vice 1, wherein a pressure element cross-section 2 projected along the cell axis 13 of at least one of the pressure elements 12 opposite a flow channel cross-section 2 projected along the cell axis 14 may be positioned so as to at least partially overlap. It is also shown that the flow channels 5 may be provided distributed in the circumferential direction U of the electrolysis device 1, wherein the normal distance N2 between the center axis 15 and the cell axis 2 of a pressure element 12 associated with the respective flow channel 5 may be less than the nor-mal distance N1 of the main direction 6 to the cell axis 2 of the respective flow channel 5.

This embodiment produces the advantageous effects already described, wherein an embodiment is also conceivable in which the normal distance N1 may be less than or equal to the normal distance N2. This possible embodiment is conceivable if design advantages outweigh other possible embodiments. In order to achieve the advantageous effects described above, it is also conceivable to use pressure elements 12 with a directional force effect due to the de-sign.

FIG. 6 shows an embodiment of a pressure plate 9 and the flow channel 5 through the plate-shaped elements 4, wherein the same reference signs or component designations are used for the same parts as in the previous FIGS. 1 to 5. In order to avoid unnecessary repetition, reference is made to the detailed description for the previous FIGS. 1 to 5. FIG. 6 shows that it may be provided that pressure elements 12 may be retained or disposed in a gliding movement configuration by pockets 20 provided in the respective abutment element 8 and/or in the respective pressure plate 9 in the direction of the cell axis 2. Furthermore, the possible configuration of the flow channel 50 and 5p in the form of a respective elliptical aperture 26 is shown. This possible configuration of the electrolysis device 1 has the advantageous effects described above.

FIG. 7 shows an embodiment of a pressure plate 9y in a highly simplified and schematic representation, wherein the same reference signs or component designations are used for the same parts as in the previous FIGS. 1 to 6. In order to avoid unnecessary repetition, reference is made to the detailed description for the previous FIGS. 1 to 6. This embodiment shows that the pressure plate 9 for the elastic pressure elements 12 may be provided with flat receiving surfaces 22, which receiving surfaces 22 may be connected by means of web-like structural elements 23. The web-like structural elements 22 may be arranged with regard to the cell axis 2 in a rotationally symmetric way, so that a rotationally symmetrical pattern of recesses may result from the pressure plate 9y This embodiment produces the advantageous effects described above, wherein it is now also possible to use plastics or less rigid materials than metals with regard to the choice of material for the pressure plate 9y.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

Finally, as a matter of form, it should be noted that for ease of understanding of the structure, elements are partially not depicted to scale and/or are enlarged and/or are reduced in size.

### LIST OF REFERENCE SIGNS

1 electrolysis device
2 cell axis
3 electrolytic cell
4 plate-shaped elements
5 flow channel
6 main direction
7 sealing means
8 abutment element
9 pressure plate
10 retaining element
11 distance
12 pressing element
13 pressing element cross-section
14 flow channel cross-section
15 center line
16 guide arrangement
17 first group
18 second group
19 center plane
20 pockets
21 mandrel
22 receiving surfaces
23 structural elements
24 fluid connections
25 flat side
26 elliptical aperture

1. Electrolysis device for producing gaseous hydrogen, comprising:
at least one electrolytic cell extending along a cell axis, which is constructed from plate-shaped elements arranged in a row along the cell axis,
at least two flow channels formed by apertures in the plate-shaped elements, the main directions of which extend along the cell axis,
sealing means for ensuring the tightness of the electrolysis device, the sealing means comprising:
a first abutment element and a second abutment element, which abutment elements are spaced apart from one another in the direction of the cell axis,
a first pressure plate and a second pressure plate, which are spaced apart from one another in the direction of the cell axis and are arranged between the first abutment element and the second abutment element, wherein the at least one electrolytic cell is arranged between the first pressure plate and the second pressure plate,
at least one retaining element, which is configured to retain the first abutment element and the second abutment element along the cell axis at a predetermined distance, and
at least one elastically deformable pressure element between a pair of an abutment element and a pressure plate, characterized in that:
at least one elastically deformable pressure element is associated with each of the flow channels, and
that a pressure element cross-section projected along the cell axis of at least one of these pressure elements is positioned so as to at least partially overlap a flow channel cross-section projected along the cell axis.

2. The electrolysis device according to claim 1, wherein a pressure element is associated with each of the flow channels, and a central axis of each of the pressure elements is aligned with the main direction of the respective flow channels.

3. The electrolysis device according to claim 1, wherein the flow channels are formed by elliptical apertures in the plate-shaped elements, and each flow channel is associated with two pressure elements.

4. The electrolysis device according to claim 1, wherein the flow channels are distributed in the circumferential direction of the electrolysis device, and wherein the normal distance of the central axis of a pressure element associated with the respective flow channel from the cell axis is less than the normal distance of the main direction of the respective flow channel from the cell axis.

5. The electrolysis device according to claim 1, wherein the at least one retaining element comprises a guide arrangement, the first pressure plate and/or the second pressure plate is guided adjustably relative to the first abutment element and/or the second abutment element along the cell axis.

6. The electrolysis device according to claim 1, wherein the at least one retaining element comprises at least one of a bolt, a pin, a cable or a screw, wherein the at least one retaining element passes through the first and the second pressure plate in the direction of the cell axis.

7. The electrolysis device according to claim 1, wherein the elastically deformable pressure elements are formed by at least one of helical springs, disc springs, or equally layered disc springs, wherein a first group of these pressure elements is passed through by a respective retaining element in the direction of the cell axis.

8. The electrolysis device according to claim 7, wherein a second group of the pressure elements is formed by the pressure elements associated with the flow channels, wherein the pressing elements of the second group have a different pressure force than the pressure elements of the first group.

9. The electrolysis device according to claim 1, wherein the at least one elastically deformable pressure element is arranged between each of the nearest pairs of an abutment element and a pressure plate.

10. The electrolysis device according to claim 9, wherein the sealing means is designed asymmetrically with respect to the number and/or configuration of the elastically deformable pressure elements relative to a center plane of the electrolysis device aligned normal to the cell axis.

11. The electrolysis device according to claim 1, wherein the at least one elastic pressure element is retained so as to slide in the direction of the cell axis by means of pockets provided in the respective abutment element and/or in the respective pressure plate and/or a mandrel and is retained so as to be positioned relative to the cell axis.

12. The electrolysis device according to claim 1, wherein the stiffness of a pressure plate is less than or equal to the stiffness of the abutment element closest to it.

13. The electrolysis device according to claim 1, wherein the pressure plate for the elastic pressure elements includes flat receiving surfaces, and wherein the receiving surfaces are stiffened by means of web-like structural elements.

14. The method for sealing an electrolysis device according to claim 1, wherein
a first pair of a pressure plate and a nearest abutment element with pressure elements associated with this first pair are pretensioned by means of a pretensioning device and arranged along the cell axis,
at least one electrolytic cell made up of plate-shaped elements is lined up next to the first pair along the cell axis,
a second pair of a pressure plate and a nearest abutment element with pressure elements associated with this second pair is pretensioned by means of a further pretensioning device and is then lined up next to the at least one electrolytic cell along the cell axis,
the abutment element of the first pair is retained at a predetermined distance from the abutment element of the second pair by means of at least one retaining element,
each pretensioning device is released from the respective pair of pressure plate and abutment element, and
the pre-tensioning force of the sealing means is finely adjusted by means of the at least one retaining element, so that the sealing of the plate-shaped elements of the at least one electrolytic cell with respect to its surroundings is achieved.
